(19) United States
(12) Patent Application Publication
(10) Pub. No.: US 2007/0245515 A1
(43) Pub. Date: Oct. 25, 2007

(54) Holder for rod shaped body

(75) Inventor: Masateru Kadota, Osaka-shi (JP)

Correspondence Address: JORDAN AND HAMBURG LLP, 122 EAST 42ND STREET, SUITE 4000, NEW YORK, NY, 10168, US

(73) Assignee: LIBERTY JAPAN LIMITED, Osaka-shi (JP)

(21) Appl. No.: 11/409,875

(22) Filed: Apr. 24, 2006

(51) Int. Cl. B43L 19/00

(52) U.S. Cl. 15/433

(57) ABSTRACT

A holder for holding an eraser of an angular shape cross section is provided, which holder moves the eraser forward little by little by the knocking operation. The holder includes an inner case, an outer case, a clamp means, a chuckling, and a spring. An arm is formed at a distal end of the inner case as one part of the clamp means, and clamp nails for clamping the eraser are formed at the distal end of the arm. The eraser moves forward by a certain dimension by moving the inner case forward and backward. The spring is formed flat and in a zigzag shape, and arranged in a flat space between the flat part of the inner case and the flat part of the outer case. Since the spring is not a spiral shape, the smooth movement of the inner case is ensured even if the inner case and the outer case are angular shape.

### BACKGROUND OF THE INVENTION

1. Field of the Invention

The present invention relates to a holder for pushing out little by little a rod shaped body that wears out through use such as a rod shaped eraser by a knocking operation.

2. Description of the Related Art

An eraser holder is known as a knocking type holder for a rod shaped body. The eraser holder includes, as a basic configuration, an inner case to which the rod shapederaser is fitted in a freely sliding manner, an outer case to which the inner case is fitted so as to be movable in the front and back direction by a predetermined stroke, achuck means for pushing out the eraser from the distal end of the outer case by a predetermined dimension through the front and back slide of the inner case, and a spring for pushing the inner case in the backward direction.

The chuck means includes a plurality of clamp nails for grasping the eraser, and a chuck ring for surrounding the clamp nails from the outer side. The clamp nail and the chuck ring relatively move by the reciprocating movement of moving the inner case forward against the spring by the knocking or push-out operation and moving the inner case backward by the spring force, and clamping and clamping release on the eraser is performed by the clamp nails. A configuration in which the clamp nails are provided as a separate body from the inner case is disclosed in Japanese Laid-Open Patent Publication No. 11-170 768, and a configuration in which a group of clamp nails are integrally formed with the inner case is disclosed in Japanese Laid-Open Patent Publication No. 7-205585.

A compression coil spring with line material winded in a spiral form is used as the spring, and the spring is arranged in the space between the inner case and the outer case in Japanese Laid-Open Patent Publication No. 11-170768 and in Japanese Laid-Open Patent Publication No. 7-205585. In Japanese Laid-Open Patent Publication No. 2006-56086, the spring is arranged at the back of the inner case.

### SUMMARY OF THE INVENTION

The eraser having a circular cross section (perfect circle) manufactured through extrusion process is used as the conventional eraser used in the knocking type eraser holder, and thus the inner case and the outer case are both cylindrical. The coil spring that is circular when seen in the extending direction is also used as the spring.

Since the conventional knocking type eraser holder only corresponds to the eraser of columnar shape, the design is more or less the same or the design lacks in diversification. Further, when desiring to exactly erase a narrow portion when using the eraser, it becomes difficult to erase only the narrow portion since the erase cannot be angulated when made into a columnar shape.

One type of eraser is a foaming type referred to as a foam eraser. This eraser has an advantage in that it has excellent erasing ability and in that the eraser debris becomes a clusterd thus can be easily taken care of due to the presence of finite number of microscopic air bubbles. Although, the commercial value can be enhanced if the foam eraser is installed in the knocking type holder, it becomes difficult to use the foam eraser having excellent quality in the conventional eraser holder since the foam eraser is difficult to manufacture through extrusion process and is difficult to be formed into a columnar shape.

The above problems are relieved by forming the eraser into a polygon, for example a quadrangle in plane. The inventor of the present invention thereby attempted to invent a holder using the eraser having a quadrangle cross-section, but several problems arose when the coil spring was simply used as the spring as in the prior art.

In other words, when the inner case and the outer case are formed into a polygon such as that having a quadrangle cross section, a large space is formed between the inner case and the outer case when the circular compression spring is used as the spring, and thus a large dead space is formed thereby enlarging the holder in excess. The inner case may be formed so that the outer surface is circular and the inner surface is a quadrangle, but excess enlargement of the holder cannot be avoided since the inner case partially has a substantially thick thickness.

The spring is therefore contrived to be formed into an angular shape when seen from the extending direction. Although the holder is prevented from being large in excess since a large gap does not form between the inner case and the outer case when the spring is formed into the angular shape, the manufacturing cost increases, and the movement of the inner case is not smooth. Further, if the spring is arranged at the back of the inner case as in Japanese Laid-Open Patent Publication No. 2006-56086, the movement of the inner case can be made smooth irrespective of the cross sectional shape of the inner case and the outer case, but in this case, the configuration for arranging the spring becomes troublesome, and the entire length of the invention becomes excessively long.

The present invention aims to improve the above situations. The present invention originated from an effort to improve the eraser holder. The holder of the present invention is applicable to a rod shaped material that wears out through use such as chalk, crayon (pastel), solid glue and the like.

The holder of the present invention is provided for holding a rod shaped body that has a non-circular cross section with flat parts at the outer periphery and that wears out through use. The holder comprises, as a basic configuration, an inner case, having an elongate shape with a front end and a back end, to be slidably fitted with the rod shaped body; an outer case to be slidably fitted with the inner case; a clamp means, positioned inside the outer case, for clamping the rod shaped body; an operating part exposed on the outer side of the outer case to move the outer case forward and backward; and a spring, arranged in a space between the inner case and the outer case, for pushing the inner case in the backward direction.

The front ends of the inner case and the outer case are both opened to allow the rod shaped body to project out, the rod shaped body moving forward by a certain dimension in relation to a series of operations of the inner case of moving forward and then moving backward.

In the present invention, the inner case and the outer case have a flat part substantially parallel to the flat part of the rod shaped body and have a cross sectional shape similar to the rod shaped body, so that one or a plurality of flat space is formed between the flat part of the inner case and the flat part of the outer case; and the spring is arranged in the flat space between the inner case and the outer case and formed into a non-spiral shape that does not surround the outer periphery of the inner case.

As mentioned above, the movement of the inner case is not smooth when the spring is formed into an angular spiral shape. The reason for this is not precisely recognized, but one reason is believed to be because the spring expands r narrows when seen from the extending direction when the spring extends. That is, when the spring expands, narrows, or deforms, a phenomenon in which the spring contacts the inner case or the outer case occurs, thereby inhabiting the smooth movement of the inner case. Since the spring is a non-spiral shape in the present invention, the phenomenon of contacting the outer case or the inner case in extension is avoided, thereby realizing a smooth movement of the inner case.

In a suitable aspect of the present invention, the spring is formed flat and bent in a zigzag shape so as to be arranged in one flat space between the inner case and the outer case.

When the spring is formed into a flat shape, the phenomenon of contacting the inner case and the outer case is reliably eliminated, and the smooth movement of the inner case is guaranteed. The present invention is applied to the eraser holder as a suitable application. The operating part of the present invention includes a knocking part exposed at the back of the outer case, and a projection projecting to the outer side of the outer periphery of the outer case.

In the suitable aspect of the present invention, the inner case and the outer case are both made of synthetic resin, and have a square cross section with four flat parts; the clamp means includes clamp nails integrally formed at the front end of each flat part in the inner case, and an angular cylindrical chuck ring for surrounding the group of clamp nails from the outer side, a slit opened towards the front is formed between the adjacent clamp nails to have the portion between the adjacent slits as an arm that bends and deforms to allow the rod shaped body to be clamped and clamp released with the group of clamp nails.

The inner case moves forward and returns by means of the spring, but in order to push out the rod shaped body, either the rod shaped body is not completely returned even if the inner case returns, or the returning amount of the rod shaped body must be smaller than the returning amount of the inner case. As a specific configuration for ensuring such condition, in the present invention, the opening of the outer case is formed to a size or producing friction resistance with the rod shaped body, and the chuck ring for releasing the clamping of the rod shaped body by the clamp nails in the process of moving the inner case backward from the forward moved state is arranged inside the front of the outer case.

In the suitable aspect of the present invention, the knocking part is manufactured as a separate body from the inner case, the knocking part being attached to the inner case by being fitted therein, and the knocking part being arranged with a clip extending in the same direction as the outer case. The fabrication and assembly of the inner case and the knocking part are facilitated with such configuration.

### BRIEF DESCRIPTION OF THE DRAWINGS

FIG. 1 is a perspective view of an outer appearance of a holder;

FIG. 2 is a separated plan view showing one part in a cross sectional view;

FIG. 3 is a perspective view with the members in a separated state;

FIG. 4 is a cross sectional view taken along line IV-IV of FIG. 1;

FIG. 5 is a cross sectional view taken along line V-V of FIG. 1;

FIG. 6 is a view showing the movement;

FIG. 7 is a view showing a second embodiment;

FIG. 8 is a view showing a third embodiment;

FIG. 9 is a view showing a fourth embodiment;

FIG. 10 is a view showing a fifth embodiment;

FIG. 11 is a view showing a sixth embodiment;

FIG. 12 is a view showing a seventh embodiment; and

FIG. 13 is a view showing an eighth embodiment.

### DETAILED DESCRIPTION OF THE PREFERRED EMBODIMENTS

An embodiment in which the present invention is applied to an eraser holder will now be described. The terms “front, distal, back” are used to indicate directions in the present embodiment, but front and back or front and rear are termed with the direction of pushing out the eraser as the reference.

(1) Structure of First Embodiment

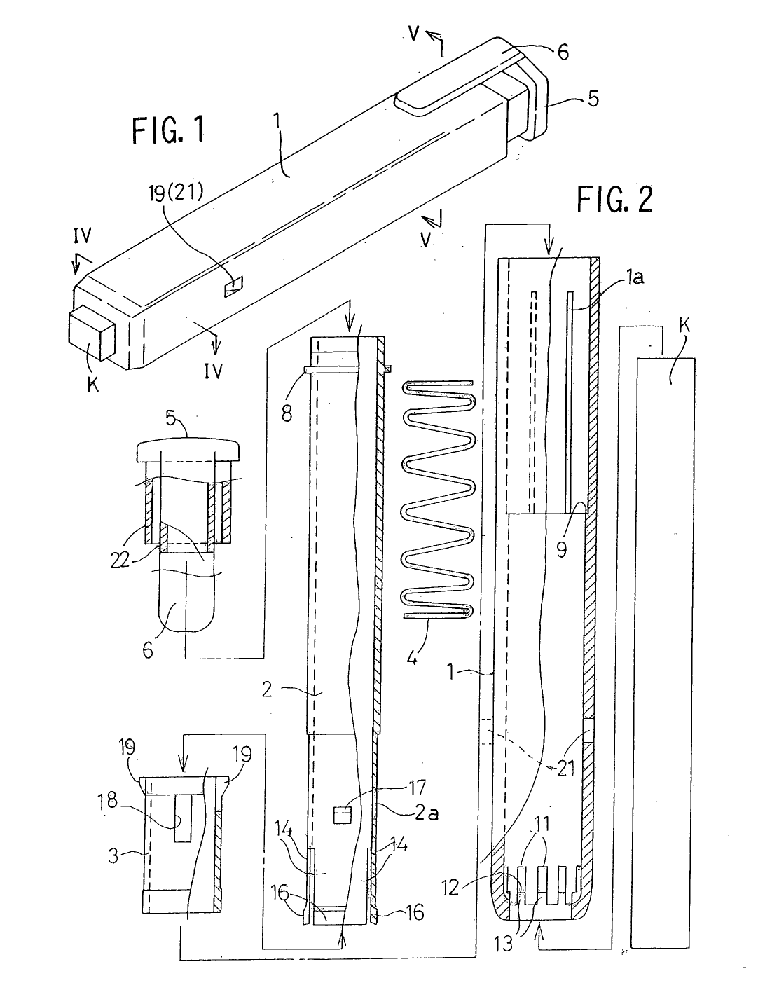

A first embodiment will first be described based on FIG. 1 to FIG. 6. The structure will first be explained.

A holder includes an outer case (main body case) 1 of hollow angular shape with openings at both ends, an inner case 2 of hollow angular shape slidably arranged inside the outer case 1, a chuck ring 3 of angular tube arranged at the front part of the outer case 1 and fitted to the distal end of the inner case 2 from the outside, a pair of springs 4 arranged between the inner case 2 and the outer case 1, and a cap 5 removably attached to the back end of the inner case 2, the cap 5 being integrally formed with a clip 6. Each component except for the spring 4 is made of synthetic resin but may be made of metal. In FIG. 5, only one of the pair of springs 4 is shown.

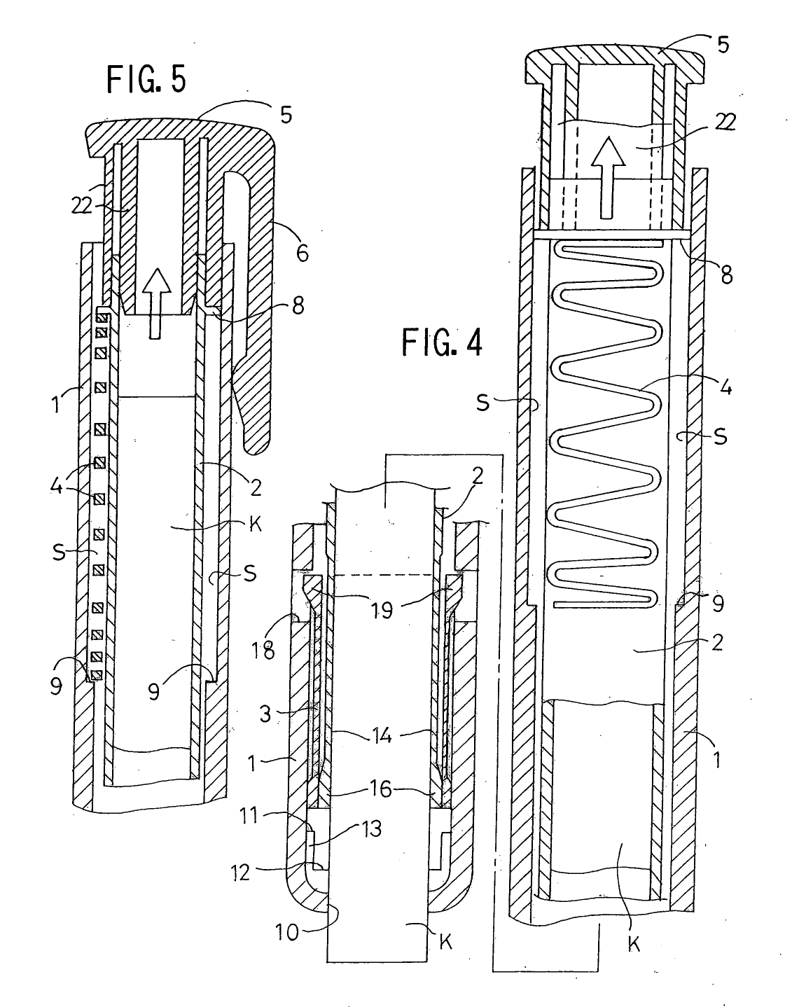

The eraser K used in such holder is formed into a rod shape with a rectangular cross section, and the inner case 2 is set so that the eraser K is slidably fitted therein without forming a gap. The inner case 2 and the outer case 1 both have a rectangular cross sectional shape that is substantially similar to the cross sectional shape of the eraser K. Therefore, both the inner case 2 and the outer case 1 each have four flat parts (flat plate part) extending parallel to the flat surface of the eraser K. Four flat spaces S are provided between the flat part of the inner case 2 and the flat part of the outer case 1, as shown in FIG. 4 to FIG. 6, and the spring 4 is arranged at the back part of two flat spaces S extending parallel to each other.

A flange 8 extending across the entire periphery is formed at a location closer to the back end of the inner case 2, which the flange 8 also enters inside the outer case 1. The flange 8 has a spring receiving function of receiving the back end of the spring 4, and a stable member function for holding so that the back part of the inner case 2 does not move. On the other hand, the front half of the outer case 1 is substantially formed to a thick thickness, and a first step 9 is formed on the inner surface of the outer case 1. The front end of the spring 4 is supported at the step. As shown in FIG. 2, a rib 1a is formed on the inner surface at the thin thickness part of the outer case 1.

The spring 4 is made by bending a line member (spring steel) of angular cross section into a zigzag shape (or wave shape) and is entirely formed into a flat shape. In the present embodiment, the spring 4 is arranged in a flat space S formed between the wide width surfaces of the inner case 2 and the outer case 1, but may be arranged in the flat space S formed between the narrow width surfaces of the inner case 2 and the outer case 1 (in this case, the width of the spring 4 is made small). Further, four springs may be arranged or only one may be arranged on the four surfaces of the inner case 2, but suitably, a pair of springs is arranged taking into account cost and smoothness of the movement.

An open hole 10 at the distal end of the outer case 1 is set to a dimension that allows the eraser K to slide with a slight friction resistance, and thus the distal end of the outer case 1 is narrowed. A plurality of ribs 13, including a second step 11 that rises from the inner surface of the outer case 1 and a third step 12 that rises towards the open hole 10, are formed at an appropriate spacing in the peripheral direction on the inside at the location closer to the distal end of the outer case 1. The second step 11 and the third step 12 may be formed in a continuous state across the entire periphery (rib 13 is not necessarily required).

An arm 14 divided with slits 15 positioned at the corners is formed at the front part of the inner case 2. Therefore, the arm 14 is a cantilevered. An outward clamp nail 16 is formed at the distal end of each arm 14, and the base of the clamp nail 16 is an inclined surface 16a. The arm 14 is set to slightly open outward (so as to deflect outward) in a free state or when not subjected to an external force.

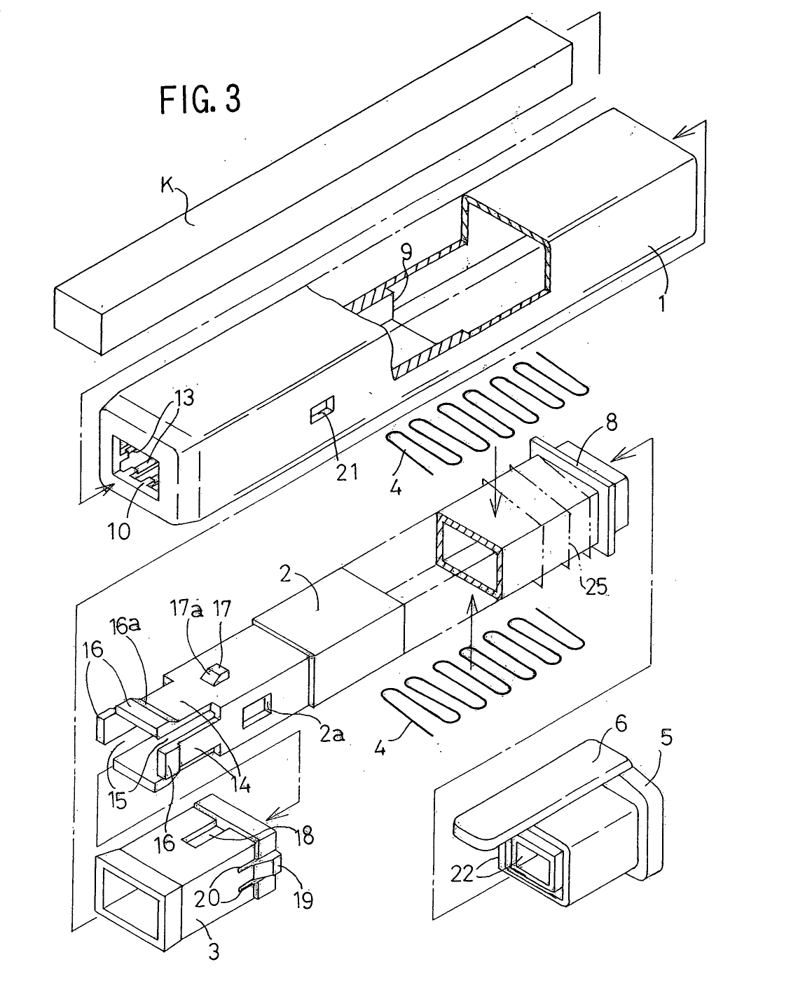

The chuck ring 3 is formed into an angular tube shape so as to slide inside the outer case 1 without rattling, and relatively moves with the inner case in the range of the forward movement position at which a group of arms 14 is completely covered and a backward movement position at which the clamp nail 16 is exposed. In order to regulate the relative movement stroke of the chuck ring 3 and the inner case 2, an outward projection 17 is formed at both wide width surfaces of the inner case 2, and an elongate hole 18 is formed at the wide width part of the chuck ring 3. For instance, the back end surface of the projection 17 is cut at right angle to the wide width surface of the inner case 2, and the front end surface of the projection 17 is an inclined surface 17a, as can be understood from FIG. 3.

A stopper nail 19 that projects outward is formed at the back part of both narrow width parts (side surface parts) in the chuck ring 3, and an angular shape engagement hole 21 to be fitted with the stopper nail 19 is formed at the narrow width part of the outer case 1. The stopper nail 19 is a cantilevered shape due to the presence of the slit 20, and thus bends and deforms on both inner and outer-sides with the base as the supporting point. The front end of the stopper nail 19 is an inclined surface. When the chuck ring 3 is fitted into and inserted to the outer case 1 from the back part, the stopper nail 19 elastically deforms so as to bend to the inner side, and deforms back thereby fitting into the engagement hole 21. A window hole 2a is opened at the inner case 2 to prevent interference with the stopper nail 19 (see FIG. 3).

Since the chuck ring 3 is fitted to the outer case 1 in a non-slip out manner by the stopper nail 19, and the inner case 2 is held in the chuck ring 3 in a non-slip out manner by the projection 17, the inner case 2 is held to the outer case 1 in a non-slip out manner. A slight clearance is formed in the front and back direction between the stopper nail 19 of the chuck ring 3 and the engagement hole 21 of the outer case 1, and thus, the chuck ring 3 slides forward and backward by a slight dimension (e.g., about 1.1-1.5 mm). The front part and the back part of the chuck ring 3 is a thick thickness part that slightly bulges out to the outer side.

Two fit-in parts 22 that fit to the inner part and the outer part of the inner case 2 are formed in the cap 5. Insertion of the eraser K into the inner case 2 may be fitted from the back with the cap 5 removed, or may be fitted from the front end by way of the open hole 10 of the outer case 1 (when fitted from the front end, it is performed with the cap 5 in the knocked state).

(2) Explanation of Movement in First Embodiment

The operation will now be explained based on FIG. 4 to FIG. 6. In a free state in which the external force is not acting on the cap 5, it is completely moved back by the inner case 2, the chuck ring 3, and the spring 4. In this state, the front end surface of the inner case 2 and the front end surface of the chuck ring 3 are aligned, as shown in FIG. 3. Thus, the eraser K is clamped (grasped) by the clamp nail 16, and the eraser K is used by having the distal end thereof pushed against the paper.

Further, as apparent from FIG. 4, in the state the inner case 2 and the chuck ring 3 are completely moved back, a slight spacing is formed between the distal end surfaces of both the inner case 2 and the chuck ring 3 and the second step 11 of the outer case 1.

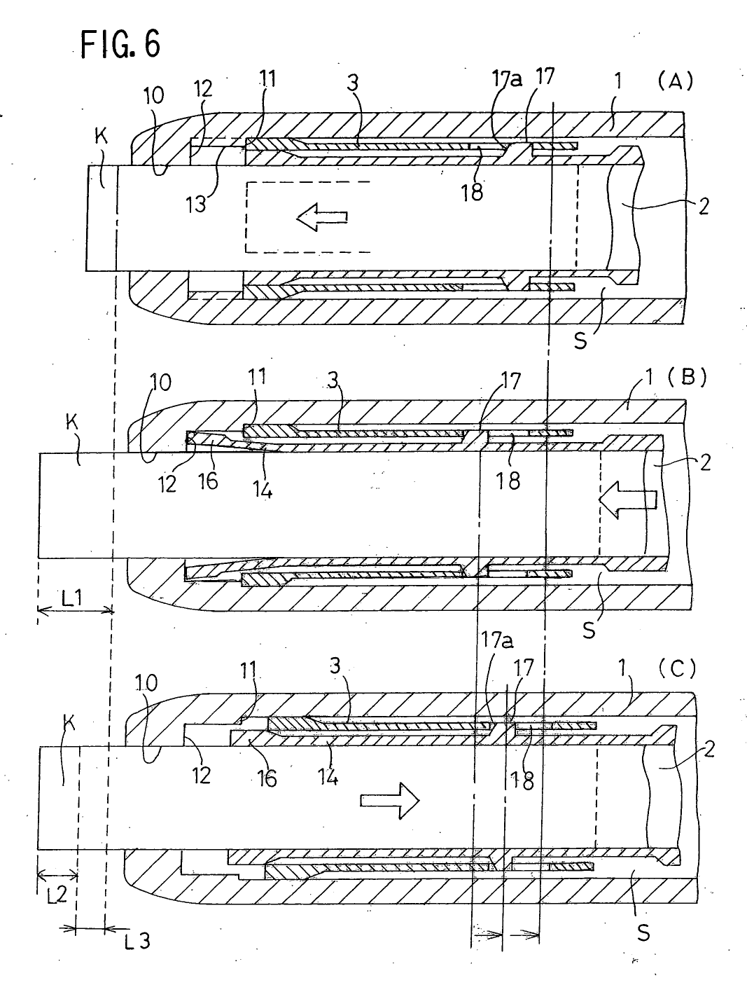

When knocking (pushing in the axial direction) the cap 5 to move the inner case 2 forward, the inner case 2 and the chuck ring 3 move forward together at the start of forward movement, and then the chuck ring 3 contacts the second step 11 of the outer case 1 and stops moving forward, as shown in FIG. 6(A). Thus only the inner case 2 moves forward thereafter. In the process of forward movement of the inner case 2, the clamp nail 16 of the arm 14 is released from the chuck ring 3, but the clamped state of the eraser K by the clamp nail 16 is held until the clamp nail 16 is released. Thus the eraser K moves forward with the inner case 2 by a constant distance L1.

When the clamp nail 16 of the arms 14 is released from the chuck ring 3, the clamping on the eraser K is released, but the eraser K sometimes moves forward with the inner case 2 due to friction with the inner case 2.

When the inner case 2 completely moves forward, the front end of the projection 17 of the inner case 2 contacts the front end surface of the elongate hole 18 of the chuck ring 3. However, since the front end of the projection 17 is the inclined surface 17a, the projection 17 slightly enters into the chuck ring 3, whereby friction occurs between the chuck ring 3 and the projection 17. Thus, when a person takes his/her finger off the cap 5, and the inner case 2 moves backward by means of the spring 4, the chuck ring 3 simultaneously moves backward with the inner case 2.

In the process of the inner case 2 moving backward, the clamping on the eraser is released until the outward projection 16 of the arms 14 fits into the chuck ring 3, and a slight friction occurs between the eraser K and the open hole 10 of the outer case 1. The eraser K thus is in a stopped state by a certain distance, the amount the inner case 2 moves backward, and thereafter, the eraser K moves backward with the inner case 2 by distance L2 simultaneously with the clamp nail 16 of the arms 14 fitting into the chuck ring 3.

Since the chuck ring 3 moves backward simultaneously with the inner case 2 in the backward movement process of the inner case 2, the distance in which the eraser K is clamped becomes shorter than the forward movement process, and as a result, the backward movement distance L2 becomes smaller than the forward movement distance L1. The eraser K is thus brought out by a distance of L3 in one knocking operation.

In the present embodiment, the clamp nail 14, the chuck ring 3, and the second step 11 cooperate to perform clamping and clamping release of the eraser K, and thus configures a specific example a clamping means described in the accompanied claims.

The circular compression coil spring with the line material winded in a circular form may be used as a spring for biasing the inner case 2 in the backward movement direction. However, since the inner case 2 is an angular shape, a large dead space forms between the inner case 2 and the outer case 1 and becomes significantly large as a whole when the circular compression coil spring is used. Further, the consumer may make a mistake since the eraser is square but the outer case is circular.

The angular shape compression coil spring 25 with the line material winded in an angular shape may be used, as shown partially by a chain dashed line in FIG. 3. However, if the spacing between the inner case 2 and the outer case 1 is narrow, the spring 25 sometimes gets stuck at the outer case thereby causing trouble. The reason for this is as described below.

In other words, in a case of a circular compression coil spring, although the outer diameter does not change by compression, the angular shape compression coil spring 25 tends to have the linear part bend with the corner as the supporting point when subjected to the compression force since the compression force acts on each location of the line material as a torsion force. The linear portion slanted with respect to the axial line of the inner case 2 thus becomes horizontal, and as a result, the spring 25 widens towards the outer side in the radial direction, and presumed to get stuck at the inner surface of the outer case. The problem of getting stuck is significant the fewer the number of windings with respect to the length (i.e., greater the lead angle).

When the flat type spring 4 in which the line material is bent in a zigzag shape is used as in the present invention, the phenomenon of trouble (phenomenon of the spring 4 getting stuck at the outer case 1 or the inner case 2) does not occur even if the spacing between the inner case 2 and the outer case 1 is narrow, and thus the inner case 2 smoothly moves forward and backward.

(3) Variation of First Embodiment

The clip 6 is formed at the cap 5 in the present embodiment, but the clip 6 may be integrally formed at the outer case 1. Further, the outer case 1 and the inner case 2 may be configured by a plurality of members. The spring 4 may be manufactured with a circular line material. The spring 4 may be held at the inner case 2 in a state that does not easily slip out. With regards to the holding means, a hole may be formed at the flange 8 of the inner case 2, and a bent part that exactly fits into the hole may be formed at the end of the spring.

(4) Other embodiments

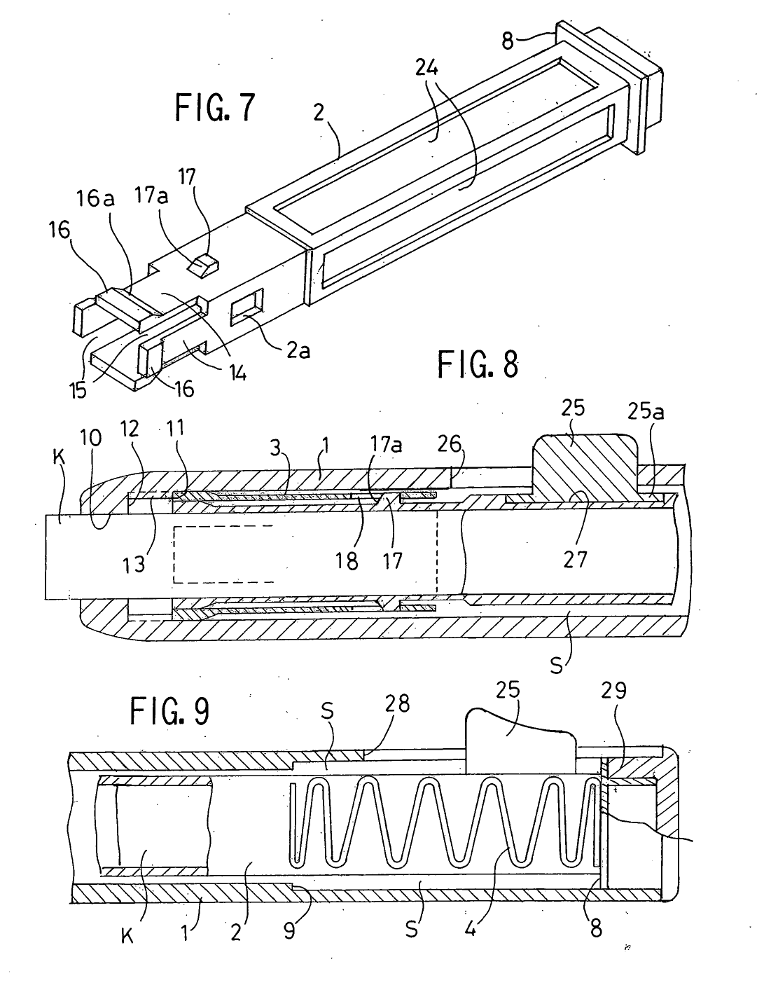

Other embodiments are shown in FIG. 7 and the subsequent figures. The second embodiment shown in FIG. 7 is a variant of the first embodiment. In this embodiment, a large draw hole 24 is formed at each flat part of the inner case 2. The inner case 2 only needs to slide while holding the eraser K, and thus may take the form shown in FIG. 7. The inner case 2 may be formed by a plurality of members.

FIG. 8 shows a third embodiment. In the present embodiment, a projection 25 projects from the outer peripheral surface of the inner case 2 as an example of an operation part. The projection 25 is exposed to the outer side of the outer case 1 through an angular shape window hole 26 formed in the outer case 1. It is obvious that a person touches his/her finger on the projection 25 and pushes the same.

In a case of the third embodiment, the projection 25 and the inner case 2 are manufactured as separate bodies, where the projection 25 is fixed to the inner case 2 with a fixing means such as an adhesive or forced fitting after fitting the inner case 2 into the outer case 1. A depression 27 for positioning the projection 25 is formed on the inner case 2. Further, the projection 25 includes a flange 25a for enhancing the fixing strength with respect to the inner case 2. The outer case 1 may be separately configured in two members and then assembled, in which case, the projection 25 can be integrally molded with the inner case 2.

The fourth embodiment shown in FIG. 9 is also an example in which the projection 25 is integrally arranged on the inner case 2. In the fourth embodiment, the projection 25 is arranged at the back end of the inner case 2. A rectangular groove hole 28 that allows the projection 25 to slide therethrough is formed in the outer case 1, and the groove hole 28 is opened towards the back. Therefore, the inner case 2 can be fitted into the outer case 1 even if the projection 25 is integrally molded with the inner case 2. A cap 29 is fitted to the back end of the outer case 1. The clip may be integrally molded to the cap 29.

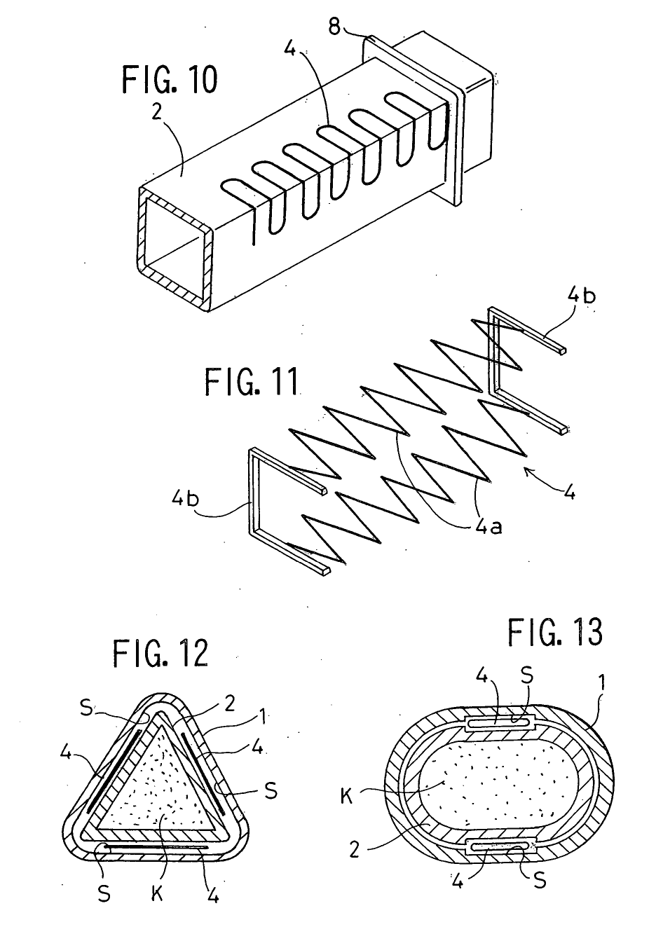

FIG. 10 shows a fifth embodiment. This embodiment is an other example of the spring. When the spring 4 is formed into a zigzag shape, it is formed into an L-shape when seen from the extending direction so as to overlap two adjacent surfaces of the inner case 2.

The spring may be manufactured with resin. Such example is shown as a sixth embodiment in FIG. 11. That is, in the sixth embodiment, the spring 4 is configured by two pairs of extending portions 4a formed in a zigzag shape, and an end member 4b coupled to both ends of the extending portions 4a.

A seventh embodiment shown in FIG. 12 and an eighth embodiment shown in FIG. 13 are other examples of the entire shape of the holder. In the seventh embodiment shown in FIG. 12, the outer case 1 and the inner case 2 are formed to have a triangular cross section including three flat parts. Therefore, the eraser K having a triangular cross section is used.

In the eighth embodiment shown in FIG. 13, the eraser has a shape of a squashed circle, which outer peripheral surface includes two flat parts and two curved parts. The outer case 1 and the inner case 2 also have two flat parts extending parallel to each other, and semicircular portions connecting the two flat parts. The flat type spring 4 is arranged in the two flat spaces S sandwiched by the flat parts of the inner case 2 and the outer case 1.

(5) Others

The specific aspects of the present invention are not limited to each of the above embodiments. For instance, the clamp means is not limited to those in the embodiment, and various mechanisms may be used (e.g., the member including the clamp nail may be formed as a separate body from the inner case).

Various shapes such as a square other than the illustrated shape may be selected for the cross sectional shape of the rod shaped body such as the eraser. Another intermediate member such as for guiding may be arranged between the inner case and the outer case, and the spring may be arranged between the inner case and the intermediate member, which configuration is also encompassed in the configuration of the present invention. The knocking part may be integrally formed at the back end of the inner case (in this case, the rod shaped body is fitted in from the front).

What is claimed is:

1. A holder for holding a rod shaped body that has a non-circular cross section with flat parts at the outer periphery and that wears out through use; the holder comprising:
an inner case, having an elongate shape with a front end and a back end, to be slidably fitted with the rod shaped body;
an outer case to be slidably fitted with the inner case;
a clamp means, positioned inside the outer case, for clamping the rod shaped body;
an operating part exposed on the outer side of the outer case to move the outer case forward and backward; and
a spring, arranged in a space between the inner case and the outer case, for pushing the inner case in the backward direction; wherein
the front ends of the inner case and the outer case are both opened to allow the rod shaped body to project out, the rod shaped body moving forward by a certain dimension in relation to a series of operations of the inner case of moving forward and then moving backward;
the inner case and the outer case have a flat part substantially parallel to the flat part of the rod shaped body and have a cross sectional shape similar to the rod shaped body, so that one or a plurality of flat space is formed between the flat part of the inner case and the flat part of the outer case; and
the spring is arranged in the flat space between the inner case and the outer case and formed into a non-spiral shape that does not surround the outer periphery of the inner case.

2. The holder for rod shaped body according to claim 1, wherein the spring is formed flat and bent in a zigzag shape so as to be arranged in one flat space between the inner case and the outer case.

3. The holder for rod shaped body according to claim 1, wherein the operating part is a knocking part positioned at the back of the outer case.

4. The holder for rod shaped body according to claim 1, wherein the operating part is a projection projecting to the outer side of the outer peripheral surface of the outer case.

5. The holder for rod shaped body according to claim 1, wherein an eraser is fitted into the inner case as the rod shaped body.

6. The holder for rod shaped body according to claim 1, wherein the inner case and the outer case are both made of synthetic resin, and have a square cross section with four flat parts;
the clamp means includes clamp nails integrally formed at the front end of each flat part in the inner case, and an angular cylindrical chuckling for surrounding the group of clamp nails from the outer side, a slit opened towards the front is formed between the adjacent clamp nails to have the portion between the adjacent slits as an arm that bends and deforms to allow the rod shaped body to be clamped and clamp released with the group of clamp nails.

7. The holder for rod shaped body according to claim 6, wherein the opening of the outer case is formed to a size or producing friction resistance with the rod shaped body, and the chuckling for releasing the clamping of the rod shaped body by the clamp nails in the process moving the inner case backward from the forward moved state is arranged inside the front of the outer case.

8. The holder for rod shaped body according to claim 3, wherein the knocking part is manufactured as a separate body from the inner case, the knocking part being attached to the inner case by being fitted therein, and the knocking part being arranged with a clip extending in the same direction as the outer case.
